(19) United States
(12) Patent Application Publication
(10) Pub. No.: US 2026/0352249 A1
(43) Pub. Date: Nov. 5, 2026

(54) Antenna Property Sensing at a Front End Module (FEM)

(71) Applicant: Apple Inc., Cupertino, CA (US)

(72) Inventors: Mohammad B. Vahid Far, Los Altos, CA (US); Kevin Bastin, Fremont, CA (US)

(73) Assignee: Apple Inc., Cupertino, CA (US)

(21) Appl. No.: 19/195,506

(22) Filed: Apr. 30, 2025

(51) Int. Cl. H04B 1/40

(52) U.S. Cl. CPC H04B 1/40

(57) ABSTRACT

The present disclosure relates to estimating a property of an antenna connected to a front-end module (FEM). This estimation is usable to control an operation of the FEM. The estimation can be performed locally at the FEM rather than at a system on-chip (SoC) connected to the FEM. For example, the FEM can include a set of sensors, each configured to generate one or more FEM parameter measurements. A look-up table can be predefined and can associate FEM parameter measurements with possible estimations of the property. Additionally, or alternatively, an artificial intelligence (AI) model can be pre-trained to output property estimations. In both cases, the FEM parameter measurements are used (e.g., in a look-up of the look-up table or as input to the AI model) to estimate the property.

### BACKGROUND

A device can include a radio frequency (RF) radio that enables communications with other devices. The communications can include transmitting a signal by a transmitter of the radio. Such a signal is typically amplified as part of the RF transmit chain.

### BRIEF DESCRIPTION OF THE DRAWINGS

FIG. 1 illustrates an example of a device that includes a transmitter, in accordance with various embodiments.

FIG. 2 illustrates an example of a front end module (FEM) that can be used in a transmitter to sense an antenna property, in accordance with various embodiments.

FIG. 3 illustrates an example of a FEM circuitry that includes FEM parameter sensors usable to sense an antenna property, in accordance with various embodiments.

FIG. 4 illustrates an example of FEM parameter measurements corresponding to different voltage standing wave ratios (VSWRs), in accordance with various embodiments.

FIG. 5 illustrates an example of estimating VSWRs based on FEM parameter measurements, in accordance with various embodiments.

FIG. 6 illustrates an example of estimating a VSWR based on FEM parameter measurements, in accordance with various embodiments.

FIG. 7 illustrates an example of an artificial intelligence (AI)-based approach for sensing an antenna property, in accordance with various embodiments.

FIG. 8 illustrates another example of an AI-based approach for sensing an antenna property, in accordance with various embodiments.

FIG. 9 illustrates an example of an operational flow/algorithmic structure for sensing an antenna property based on a FEM parameter, in accordance with various embodiments.

FIG. 10 illustrates a device, in accordance with some embodiments.

### DETAILED DESCRIPTION

The present disclosure relates to, among other things, sensing an antenna property at a front end module (FEM). The antenna property can be for example, an impedance of an antenna (also referred to as a load) or a voltage standing wave ratio (VSWR) that indicates this impedance. The FEM is coupled with processing circuitry (e.g., a system-on-chip (SoC) or a WIFI chip, a BLUETOOTH chip, or a cellular communications chip) that generates a signal for transmission by the antenna. The FEM is also coupled with the antenna and can, among other things, amplify the signal for the transmission. The antenna can be characterized by an impedance (e.g. a 50 ohm matching impedance). However, due to various factors (e.g., proximity of the antenna to an object or a surface), the antenna property can change (e.g., actual impedance). This change can impact the transmission performance.

Rather than implementing a feedback loop (e.g., similar to a digital pre-distorting (DPD) loop) to the processing circuitry, the variation to the antenna property can be sensed using one or more parameters measured locally at the FEM. Baseline FEM parameter measurements with the known impedance of the antenna (e.g., 50 ohms) can be predefined (e.g., in a laboratory environment). Based on the measured FEM parameters and the baseline FEM parameters, the variation to the antenna property can be estimated. Such an estimation can be used to adjust an operation of the FEM (e.g., change its gain to meet a target output power and/or change its power backoff to meet a specific absorption rate (SAR)). Examples of FEM parameters include current, voltage, gain, output power, error vector magnitude (EVM), adjacent channel power (ACP), input-referred intercept point (IIP) measurement, adjacent channel leakage ratio (ACLR), signal envelop, or any other parameter associated with signal processing by the FEM and measured at the FEM.

To illustrate, the FEM can include a current sensor that can measure an electrical current of the FEM as a first FEM parameter. The FEM can also include a power detector that can measure the gain of the FE'M. Baseline current measurements can be pre-collated with different VSWR values. Likewise, baseline gain measurements can be pre-correlated with different VSWR values. Each VSWR value can also be pre-correlated with a variation to the known impedance of the antenna (also referred to as antenna load). In operation (e.g., while a signal is output from the processing circuit to the antenna via the FEM, where the signal represents traffic data), the current and the gain are measured. The baseline current measurement closest to the measured current can indicate a first VSWR value. The baseline gain measurement closest to the measured gain can indicate a second VSWR value. The two VSWR values are then used to estimate the variation to the antenna load. The FEM operation can be adjusted accordingly.

The FEM-based measurements to estimate the antenna property provide several technical advantages at a device level, main logic board (MLB) level, and a FEM level. For example, the feedback loop can be avoided, thereby simplifying the circuit design and enabling a more compact circuit implementation at an MLB. Furthermore, the FEM operation can be adjusted such that an optimal transmission performance can be achieved. Additionally, the antenna load estimation can be performed without interrupting signal transmissions, thereby improving the data throughput of the device.

In the interest of clarity of explanation, specific FEM parameters are described in connection with determining a VSWR and estimating an antenna load. However, the embodiments are not limited as such. Instead, the embodiments equivalently apply to the estimation of any antenna property, where the estimation relies on local measurements performed by the FEM.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

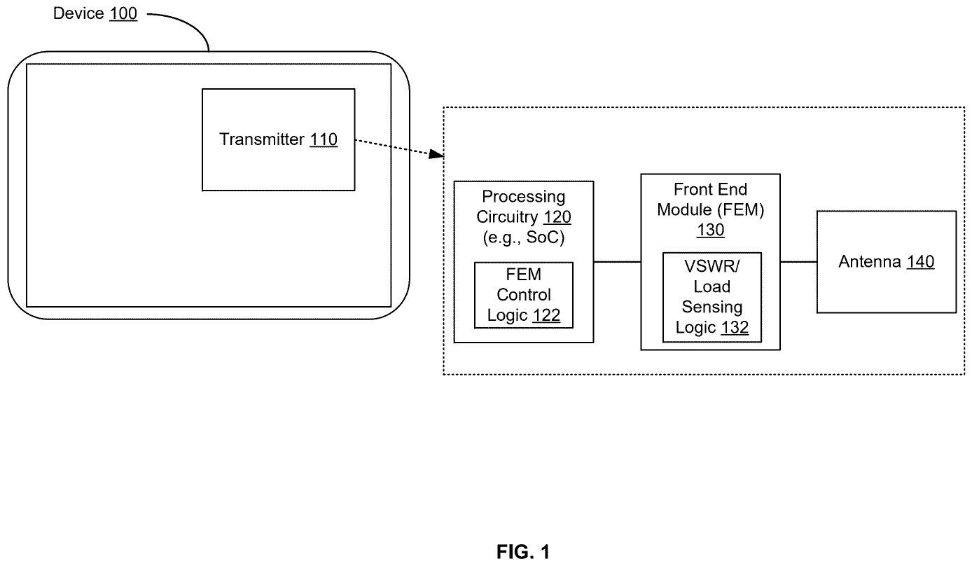

FIG. 1 illustrates an example of a device 100 that includes a transmitter 110, in accordance with various embodiments. The transmitter 110 (e.g., a digital transmitter) can enable the device 100 to transmit signals (e.g., ones encoding information according to a communication protocol, such as WIFI, BLUETOOTH, cellular, or other protocols). To do so, the transmitter 110 can include, among other components, processing circuitry 120, a FEM 130, and antenna 140. The FEM 130 is separate from and coupled with the processing circuitry 120 and the antenna 140, whereby a signal that is output by the processing circuitry 120 is amplified by the FEM 130, and the amplified signal is transmitted by the antenna 140. FIG. 1 shows a simplified diagram of components of the transmitter 110. Other components can also exist, such as a filter disposed between the FEM 130 and the antenna 140.

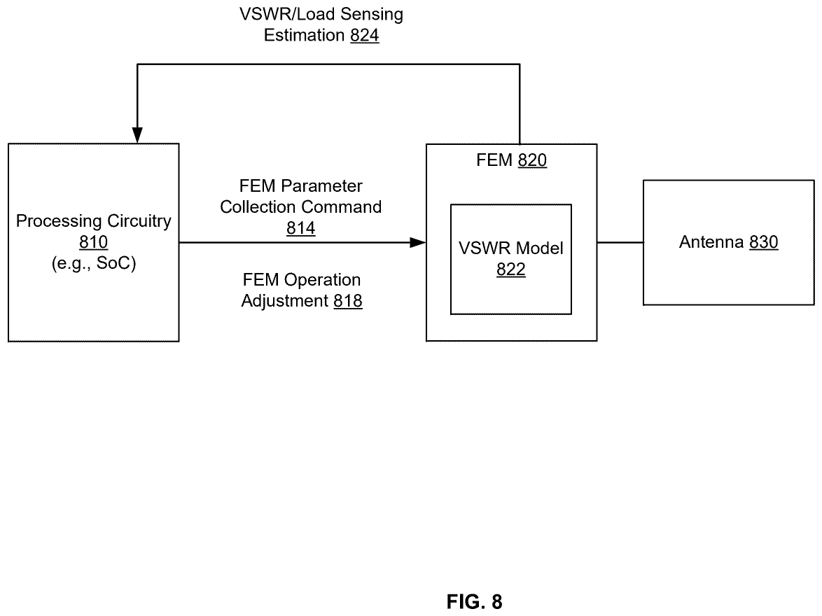

In an example, the device 100 can be an Internet of Things (IOT) device, a tablet, a smart phone, a laptop, a sensor, an appliance, or any other type of devices that supports communications (at least transmission) with other devices. In addition to the transmitter 110, the device can include other components such as one or more processors and one or more memories storing instructions executable by the one or more processors to provide different functionalities and, at least partially, control operations of the transmitter 110. Examples of such components are further illustrated in FIG. 8.

The processing circuitry 120 can process a signal (e.g., a baseband signal) for transmission. The signal can be output by the processing circuitry 120 at a first output power (and can be subsequently amplified by the FEM 130). In an example, the processing circuitry 120 can include an SoC having different processors and memories. The processing circuitry 120 can store FEM control logic 122 (e.g., as a set of instructions in the memories, where these instructions are executable by the processors). The FEM control logic 122, upon execution, can enable the processing circuitry 120 to trigger the FEM 130 to measure FEM parameters. As further described below, the processing circuitry 120 can receive such measurements, in which case the FEM control logic 122 also enables the processing circuitry 130 to estimate a VSWR and/or antenna load and control the FEM 130 accordingly. Nonetheless, it is possible that the FEM 130 itself may perform such an estimation and/or control. It may also be possible that no trigger or control of the processing circuitry 120 is implemented for the FEM parameter measurements.

The FEM 130 FEM can represent an interface between the processing circuitry 120 and the antenna 140. In the receive path, one of the FEM functions includes improving the system level sensitivity by using a low noise amplifier (LNA). Usually, insertion loss can exist between the processing circuitry 120 and the antenna 140, which degrades the receive performance. The LNA can compensate the insertion loss. In the transmit path, one of the FEM functions includes providing output RF output power by a PA to extend the dynamic range of the processing circuitry 120 (e.g., to provide an additional gain than that of the processing circuitry 120). The FEM 130 can include also several components, such as LNA, PA(s), FEM parameter sensor (as further described herein), low dropout (LDO) regulators, switches, digital sections, and several mixed signal circuitries for different purposes including FEM parameter measurements (including error vector magnitude (EVM) measurements, current measurements, gain measurements, output power measurements). Additionally, the FEM 130 can include an RF front end (RFFE) interface, besides a general purpose input/output (GPIO) and other interfaces with the processing circuitry 120, which enable the FEM 130 provide the FEM parameter measurements to the processing circuit 120, receive a trigger to perform such measurements, and/or receive a command to adjust an operation of the FEM 130 (e.g., to adjust its gain or backoff power). The FEM 130 can interface with several wireless technology sub systems (which the processing circuitry 120 can include) including WiFi, Bluetooth, ultra-wide band, and even cellular SoCs.

In an example, the FEM 130 includes a controller (e.g., a set of processors and a set of memories) that executes VSWR/load sensing logic 132 (e.g., as a set of instructions in the set of memories, where these instructions are executable by the set of processors). The VSWR/load sensing logic 132, upon execution, enables the FEM 130 to estimate VSWR value(s) based on FEM parameter measurement(s) and/or a variation to the antenna load of the antenna 140. Such an estimation can be used to control an operation of the FEM 130 (to adjust its gain and/or target backoff power). It may be possible that the processing circuitry 110 can additionally or alternatively store and execute the VSWR/load sensing logic 132.

The antenna 140 can be any type of antenna (including possible an antenna array that supports beamforming and/or MIMO communications). Generally, the input of the antenna 140 is coupled with the output of the FEM 130. The antenna can be characterized by an antenna load (e.g., an impedance). Due to various factors (e.g., proximity to an object, such as a body proximity or a hand grip, or a surface, such as a top of a table), the antenna load can vary, which can impact the transmission performance. The VSWR/load sensing logic 132, upon execution, enables controlling the operation of the FEM 130 to improve the transmission performance. It may also or alternatively be possible to control an operation of the processing circuitry 120 based on the VSWR/load sensing estimation (e.g., by adjusting its gain, its modulation scheme, or any other transmission parameters).

In an example, having an estimate on the antenna load variation is relevant to adjusting the SAR back off to adjust the radio transmit power to ensure body safety when needed. The lack of proper VSWR sensing in the situations of body proximity or hand grip can lead to excessive power backoff, which may negatively impact wireless performance and result in an unpleasant user experience. Apart from SAR, the antenna load variation also impacts the FEM performance. With the use of VSWR sensing, this variation can be detected and corrected, leading to the optimal performance of the PA.

Usually, antenna VSWR sensing can be accomplished using a directional coupler and a feedback loop to the processing circuitry 120. A similar loop for DPD operation can be implemented to measure the reflection and estimate the antenna load as a ratio of the reflected power over the transmitted power. However, such an implementation can be an expensive solution in terms of circuitry complexity, space constraints, and actual costs, and may not be available in many platforms (e.g., many WiFi FEMs are implemented without DPD). Adding this feature with a feedback loop to the processing circuitry 120 has implications for the processing circuitry 120, the main logic board (MLB), and the FEM 130.

Additionally, in many cases like SAR, it may not be necessary to know the exact antenna load magnitude or phase. Instead, determining if there has been a significant change in the load may be sufficient to adjust the SAR backoff. As shown in FIG. 1 and in the next figures, rather than using directional coupler and a feedback loop to the processing circuitry 120, a standalone Antenna VSWR sensing system at the FEM level can be implemented, eliminating the need for any feedback loop to detect significant variations in the antenna load. This system can re-use many of the existing FEM components (e.g, current sensor, power detector, temperature sensor) without the need for added circuit complexity.

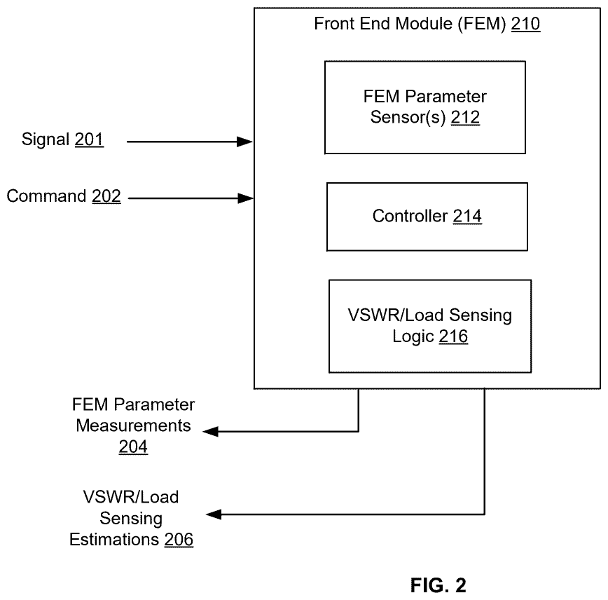

FIG. 2 illustrates an example of a FEM 210 that can be used in a transmitter to sense an antenna property (e.g., the transmitter 110 to sense the antenna load), in accordance with various embodiments. The FEM 210 can receive a signal 201 from an SoC (an example of the processing circuitry 120), where the signal 201 represents data to be transmitted, upon modulation, via an antenna. The FEM 210 can amplify the signal 201. The modulation can be a standard modulation (e.g., OFDM) or a special waveform (e.g., a continuous waveform).

The FEM 210 can also receive a command 202 from the SoC to perform FEM parameter measurements and/or VSWR/load sensing estimations. Triggering the FEM processing via the command 202 may be optional. For instance, it may be possible that the FEM 210 is programmed to perform FEM parameter measurements and/or VSWR/load sensing estimations according to a predefined configuration (e.g., periodically, at a particular rate, etc.) without a command of the SoC.

The FEM processing may be performed without interrupting the transmission of the signal 201, thereby improving the data throughput. This can be the case when no termination mode is used. In comparison to a system that implements DPD loop to the SoC, the signal transmission would need to be interrupted. Nonetheless, when a termination mode is used for the FEM parameter measurements and/or VSWR/load sensing (further described herein below), the signal transmission may be interrupted.

In an example, the FEM 210 includes one or more FEM parameter sensor(s) 212. Each FEM parameter sensor can be used to measure one or more FEM parameters. The FEM parameters can include, for instance, gain, electrical current, EVM, output power, and the like. To measure the gain, a corresponding FEM parameter sensor can include a power detector in combination with a coupler that measures the forward power (e.g., the power used in the transmit path) and the reverse power (e.g., the power sensed in the receive oath). To measure the gain, a corresponding FEM parameter sensor can include a current monitoring circuit that monitors the variation in Icc. The EVM can be measured by comparing the ideal transmitted signal to the actual transmitted signal in terms of amplitude and phase. It can be calculated as the root mean square (RMS) of the error vector (difference between the ideal and actual signals) normalized to either the peak or RMS amplitude of the ideal signal. As such, the corresponding FEM parameter sensor for the EVM can include circuitry, such one implementing a vector signal analyzer and a digital signal processor, that can sense, quantify, and compare the signals in terms of phase and amplitude. To measure the output power, a voltage monitoring circuit (possibly with a current monitoring circuit) can be used to measure Vdet as an indication of the output power.

The FEM parameter sensors 212 can include other sensors that may not directly measure a FEM parameter but that may sense a non-FEM parameter that impacts the VSWR or load variation and that is usable in the measurement of the FEM parameter applied in the estimation estimate the VSWR or load variation. For instance, the antenna load can be impacted by the operational temperature of the FEM 210. Accordingly, the FEM parameter sensors 212 can include a temperature sensor that measures the operational temperature (an example of the non-FEM parameter). The contribution of the operational temperature to the VSWR or load variation can then be accounted for in the estimation.

In an example, the FEM parameter sensors 212 can also include an impedance termination component that supports a termination mode. This load can be an impedance load. For instance, the impedance load can have a matching impedance that corresponds to the impedance of the antenna (e.g., the two impedances are equal). In another illustration, the matching impedance of the impedance termination component is adjustable to mimic a plurality of antenna loads. Here, the impedance termination components can include a set of switchable capacitors and resistors (and possibly other passive components, such as inductors) so that the matching impedance can be extended from 50 ohms to any other impedance value. Such components can be set in parallel networks of switch capacitor banks and programmable resistors with possibly inductors.

In an example, the FEM 210 includes a controller 214 and VSWR/Load sensing logic 216. The controller 214 can execute the VSWR/Load sensing logic 216 to estimate a VSWR that indicates an antenna load (e.g., the actual antenna load that may be different than the pre-designed antenna load of, say, 50 ohms) and/or the antenna load from one or more FEM parameter measurements generated by the FEM parameter sensors 212.

Although not illustrated, the FEM 210 can include an interface to output data to the SoC. For instance, the FEM 210 can output FEM parameter measurements 204 and/or VSWR/load sensing estimations 206 to the SoC. In the case of outputting the FEM parameter measurements 204, the SoC can estimate the VSWR and/or antenna load and then send a command to the FEM 210 for controlling its operation associated with amplifying the signal 201. In the case of outputting the VSWR/load sensing estimations 206, the SoC can control the operation of the FEM 210 based on such estimations 206.

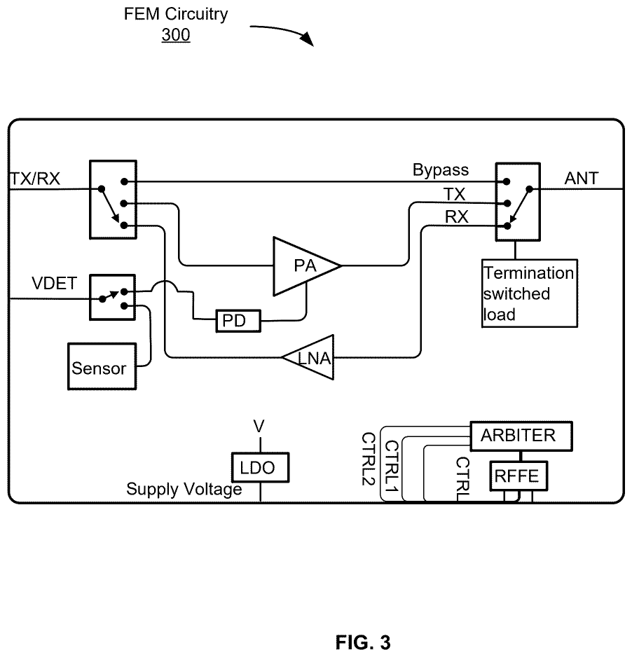

FIG. 3 illustrates an example of a FEM circuitry 300 that includes FEM parameter sensors usable to sense an antenna property, in accordance with various embodiments. The FEM circuitry 300 can be implemented as part of the FEM 210.

As illustrated, the FEM circuitry 300 supports a transmission/reception path (one in the 2 GHz frequency range, or one in the 5 GHz frequency range), although it is possible that multiple transmission/reception paths can be supported. In this path, the FEM circuitry 300 includes a set of transmit and receive switches to selectively switch between transmission and reception. In the transmission path, a PA is used. In the receive path, an LNA is used. A power detector (PD) is coupled with the corresponding PA (possibly via a bidirectional coupler). A switch to the Vdet voltage source can be connected to the PD. A sensor (e.g., a temperature sensor) is also implemented and can be connected to such a switch. Although not shown, a current sensor can be implemented in the transmission/reception path.

Additionally, a termination switched load (e.g., an example of the impedance termination component described in FIG. 2) can be selectively connected with the PA (on the transmit path) and the LNA (on the receive path) or completely disconnected (whereby the antenna is connected to the PA or the LNA as the case may be). As such, a controller of the FEM circuitry 300 can enable a termination mode in the transmit path along the transmission/reception path by controlling the switch to disconnect the antenna from the PA and, instead, connect the termination switched load to the PA.

As shown in the bottom left corner of the FEM circuitry 300, a radio frequency front end EF and various general purpose input/output (GPIO) interfaces can be available to connect the FEM circuitry 300 to an SoC (e.g., the processing circuitry 120 of FIG. 1) to enable controls therefrom and sending measurements and estimations thereto.

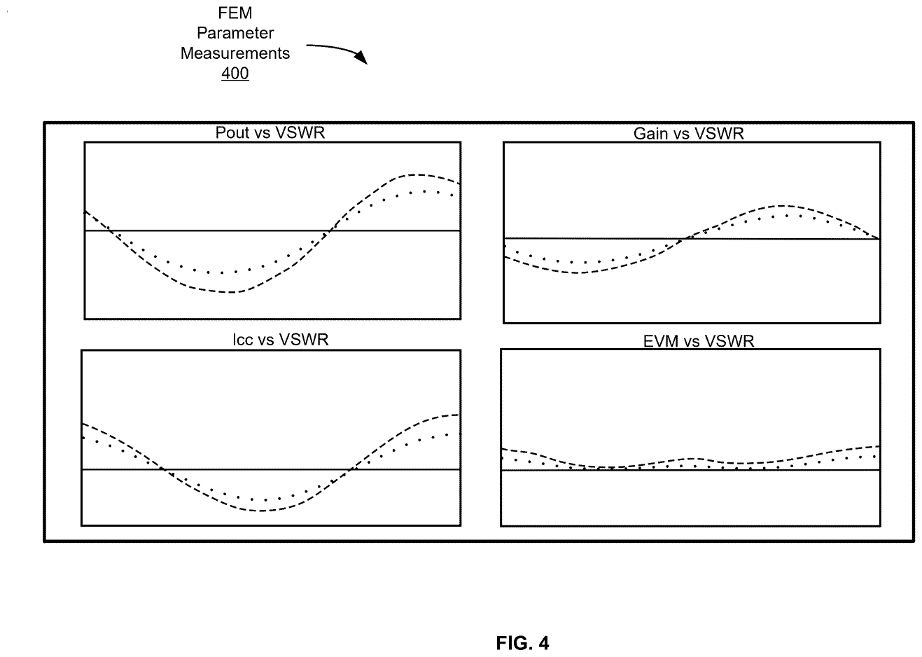

FIG. 4 illustrates an example of FEM parameter measurements 400 corresponding to different VSWRs, in accordance with various embodiments. Four FEM parameters are shown for illustrative purposes: output power, gain, current, and EVM. The measurements for each are shown for three VSWRs (a 1:1 VSWR, a 2:1 VSWR, and 3:1 VSWR). The measurements are performed across a range of signal phases and are shown as plots of the measured value as a function of the signal phase.

The top left plot represents the output power across the signal phase. The solid flat line corresponds to the output power at the 1:1 VSWR. The dotted line corresponds to the output power at the 2:1 VSWR. And the dashed line corresponds to the output power at the 3:1 VSWR.

Similarly, the bottom left plot represents the current across the signal phase. The solid flat line corresponds to the current at the 1:1 VSWR. The dotted line corresponds to the current at the 2:1 VSWR. And the dashed line corresponds to the current at the 3:1 VSWR.

The top right plot represents the gain across the signal phase. The solid flat line corresponds to the gain at the 1:1 VSWR. The dotted line corresponds to the gain at 2:1 VSWR. And the dashed line corresponds to the gain at the 3:1 VSWR.

The bottom right plot represents the EVM across the signal phase. The solid flat line corresponds to the EVM at the 1:1 VSWR. The dotted line corresponds to the EVM at 2:1 VSWR. And the dashed line corresponds to the EVM at the 3:1 VSWR.

Each of these measurements can be generated in a laboratory set up. In particular, a known antenna load is used and corresponds to one of the three VSWRs (e.g., a 50 ohm load for the 1:1 VSWR, a “k1×50” ohms for the 2:1 VSWR, and a “k2×50” ohms for the 3:1 VSWR). The different sensors then generate measurements of the output power, current, gain, and EVM across signal phases.

As shown in the plots, the measurement for each FEM parameter at a particular signal phase can be correlated with a VSWR. This correspondence is further illustrated in the next two figures. Accordingly, by measuring one or more of the FEM parameters, it may be possible to estimate the corresponding VSWR. More particularly, in the laboratory set up, calibration data can be generated and correspond to a plurality of antenna loads, each corresponding to a VSWR. Such calibration data can be stored (as look-up data in a look up table). In operation, a FEM parameter can be measured at a particular signal phase (or multiple phases) and the measurement(s) to look up the calibration data corresponding to that FEM parameter to find the closest match. The closest match is associated in the look-up data with a VSWR (e.g., one of the 1:1 VSWR, 2:1 VSWR, or 3:1 VSWR). This VSWR represents an estimated VSWR and can also be associated with in the look-up data with the corresponding antenna load. Therefore, the antenna load can also be estimated based on the measurement(s) of the FEM parameter(s).

FIG. 4 illustrates an example of four FEM parameters and three VSWRs. However, the embodiments of the present application are not limited as such. Any number and/or type of FEM parameters can be correlated, via laboratory measurements, with any number of VSWRs corresponding to any number of antenna loads and the measurements, VSWRs, and antenna load can be captured as calibration data in one or more look up tables.

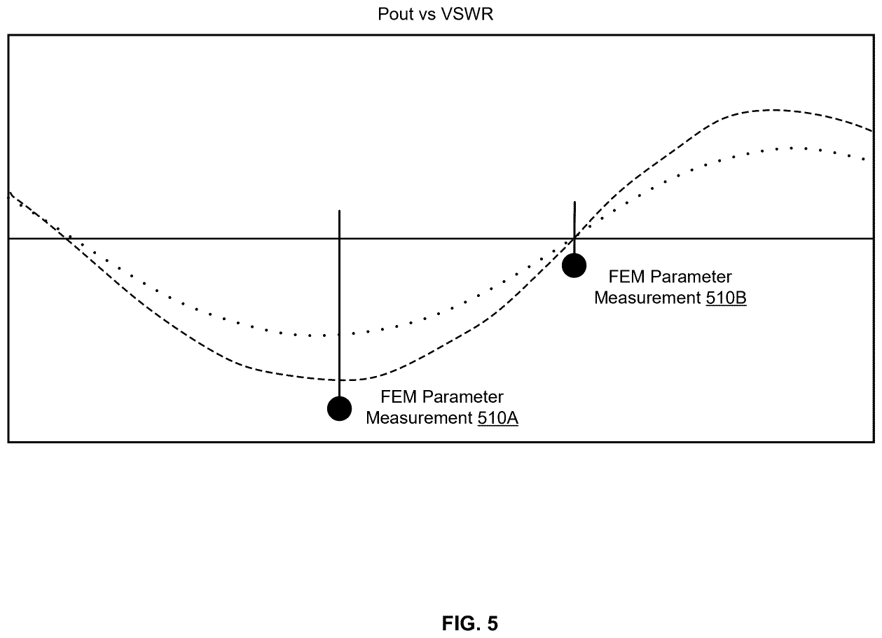

FIG. 5 illustrates an example of estimating VSWRs based on FEM parameter measurements, in accordance with various embodiments. Calibration data for a FEM parameter (shown as output power) corresponding three VSWRs (1:1, 2:1, and 3:1 as in FIG. 4) is shown as a plot across a signal phase.

Say that in operation, a first FEM parameter measurement 510A is generated (shown as a black solid circle). This measurement can be compared to the calibration data to find the closest match (this comparison is shown with the vertical line and would correspond to a look-up of the calibration data in a look-up table). Here, the closest match happens to belong to the FEM parameter corresponding to the 3:1 VSWR. As such, the 3:1 VSWR can be estimated given the FEM parameter measurement 510A.

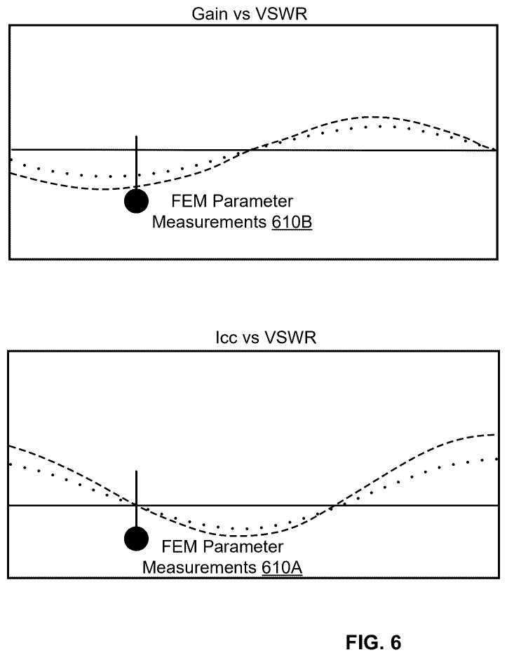

In comparison, say that in operation, a second FEM parameter measurement 510B is generated instead (also shown as a black solid circle). This measurement can be compared to the calibration data to find the closest match (this comparison is shown with the vertical line and would correspond to a look-up of the calibration data in a look-up table). Here, the closest match happens to possibly belong to any of the three VSWRs. As such, the estimation of the VSWR given the FEM parameter measurement 510B may not be accurately completed. To improve the accuracy or the confidence in the VSWR estimation, multiple FEM parameters can be used as shown in FIG. 6.

FIG. 6 illustrates an example of estimating a VSWR based on FEM parameter measurements, in accordance with various embodiments. Here, rather than using a single FEM parameter to estimate VSWR, multiple FEM parameters are used. In the illustration of FIG. 6, two FEM parameters are shown: gain and current, although a different combination and/or number of FEM parameters can be used.

As illustrated, say that in operation, a first FEM parameter measurement 610A for the current is generated (shown as a black solid circle). This measurement 610A can be compared to the current calibration data to find the closest match (this comparison is shown with the vertical line and would correspond to a look-up of the current calibration data in a look-up table). Here, the closest match happens to possibly belong to any of the three VSWRs. As such, the estimation of the VSWR given the first FEM parameter measurement 610A (current measurement) may not be accurately completed.

Instead, for that same signal phase, a second FEM measurement 610B is generated (e.g., a gain measurement). This measurement 610B can be compared to the gain calibration data to find the closest match (this comparison is shown with the vertical line and would correspond to a look-up of the gain calibration data in a look-up table). Here, the closest match happens to belong to the gain corresponding to the 3:1 VSWR. As such, the 3:1 VSWR can be estimated given the second FEM parameter measurement 610B (gain measurement).

In an example, a priority can be defined for the different FEM parameters to resolve conflicts. For instance, say that a current measurement is resolved to a 2:1 VSWR, whereas a gain measurement is resolved to a 3:1 VSWR. If the current parameter has a higher priority, the 2:1 VSWR is declared to be the estimation. In another example, to resolve a conflict, confidence values used. A confidence value can depend on how close a measurement is to the corresponding calibration data. Say that the current measurement is a closer match to the 2:1 VSWR than the gain measurement is to the 3:1 VSWR, the 2:1 VSWR is declared to be the estimation.

As explained herein above, FEM parameters like gain, current, and EVM vary over the antenna load which can be correlated with VSWR. By monitoring the variation of FEM parameters, estimating the variation over the antenna load is possible.

In certain situations, non-FEM parameters, such as temperature, can affect the variation to the antenna load. For a more robust estimation that can minimize the secondary effect, monitoring variations of multiple FEM parameters can be used. Doing so can eliminate the error resulting from the potential poor sensitivity of one parameter to variation over the load in certain phase angles.

In an addition or alternative to monitoring multiple FEM parameters, a termination mode within the FEM can be used to generate measurements. Particularly, calibration data corresponding to FEM measurements can be generated and stored for one or more antenna loads under known non-FEM parameters that may impact the antenna load estimation (e.g., temperature, voltage, FEM manufacturing part variations and tolerances, etc.). In operation, the termination mode can be activated to mimic one of the antenna loads (e.g., a 50 ohm impedance load). In operation, a FEM parameter measurement can be generated, where the antenna load is unknown and is to be estimated. The non-FEM parameter can also be measured to then remove the contribution of this non-FEM parameter to the FEM parameter measurement, which can improve the antenna load estimation.

To illustrate, consider the example of temperature. Calibration data that associates gain measurements (as an example of a FEM parameter) with VSWR and/or antenna load for a baseline temperature value (or a baseline temperature range) can be generated and stored in a look-up table. Gain measurements can be additionally performed for different temperature values (or temperature ranges). The difference between gain measurement between the baseline temperature and the non-baseline temperature corresponds to the contribution of the non-baseline temperature to the gain measurements. This difference can be stored in the calibration data as the temperature-to-gain contribution and can be associated with the non-baseline temperature (or a non-baseline temperature range). In operation, the gain can be measured (e.g., by a PD of the FEM) as well as the temperature (e.g., by a temperature sensor of the FEM). The temperature can be used in a look-up of the calibration data to determine the relevant temperature-to-gain contribution. This contribution can then be removed from the measured gain (e.g., can be subtracted therefrom), resulting in a adjusted gain measurement. In turn, the adjusted gain measurement can be used to estimate the VSWR and/or the antenna load as described in FIGS. 5-6.

In an example, further robustness to the VSWR and/or antenna load estimation can be achieved by using use multiple frequency measurements to compensate for the error induced by the phase shift associated to FEM's internal components including the PA output matching network (OMN). Particularly, a phase shift exits between the load at the PA of the FEM, the load at the output of the FEM, and the load at the antenna. The phase shift error may be induced by components between the PA and the antenna. This shift at the PA output and FEM output may be contributed by OMN, for example. This shift rotates as the frequency of operation changes. Using data from multiple frequencies can be used to estimate the shift and better estimate the VSWR and the antenna load.

In an example, a look-up table (LUT) data set of characterized FEM responses (variations in parameters such as gain and current) across various VSWR values (or antenna loads) can be predefined as a reference (e.g., baseline). The FEM parameter measurements can be compared to the reference LUT to estimate the antenna load variation. In other words, reference FEM parameter variations over VSWR can be stored in a LUT to be used as a reference to estimate the antenna load change based on actual FEM parameter measurements. A factory calibration can be used to mitigate error induced by non-FEM parameters (e.g., temperature, part-to-part variation, etc.). The LUT can be adjusted by the factory calibration over one/several antenna loads. The calibration can be adjusted as the number of data of points increases.

For the gain variation measurements, Vdet can be used to measure the output power and use that as a metric for the power change. For the current variation measurements, a current monitoring circuit can be used to monitor the variation in Icc.

The monitoring of the FEM parameters can happen in real time by using the actually modulated signal (e.g., the OFDM signal in the WiFi or cellular situations). Background monitoring is possible, where this monitoring can use a continuous wave (CW) or the modulated signal. The use of the CW can interrupt the transmission of the modulation signal and can be implemented, for example, along with the activation of a termination mode.

The FEM can include one or more memories (e.g., FEM registers) used to store some or all of the measurements and/or look-up data. The FEM can have a radio frequency front end interface (or some other interface) with access to some the memory addresses (e.g., some of the registers). This interface can enable an SoC to read the measurements and/or look-up data.

The FEM parameter monitoring and/or VSWR/load sensing can be initiated or controlled by the SOC. Alternatively, the FEM parameter monitoring and/or VSWR/load sensing can be implemented as a FEM level stand alone function.

In an example, a termination mode can be used extended from one fixed matching impedance value to a switched resistor and capacitor circuit (that may also include other passive components). For example, a parallel network of switch capacitor bank and programmable resistors can be used. This can mimic different load to the FEM's PA. Some inductor also can be added as needed.

A current monitoring circuit can be added to the PA to capture the Icc variation over the load. A bidirectional coupler with both forward and reverse path can be used to estimate the reflection using the Vdet circuitry.

In an example, VSWR can be actually measured rather than estimated at the FEM. For example, the FEM includes the bidirectional coupler and a power detector connected thereto. The bidirectional coupler can be activated in the forward path, whereby a power detector can then measure the forward power. The bidirectional coupler can then be activated in the reverse path, whereby the power detector can measure the reverse power. The ratio of the two power measurements can represent a FEM-level measurement of VSWR.

In a further example, antenna isolation can be measured. Say that the radio frequency front end includes multiple antennas. On the FEM transmit path connected to one of the antennas, a power detector of this path can measure the power output. On the FEM receive path connected to another antenna, a power detector of this path can measure the received power. The difference between the two power measurements can represent the antenna isolation.

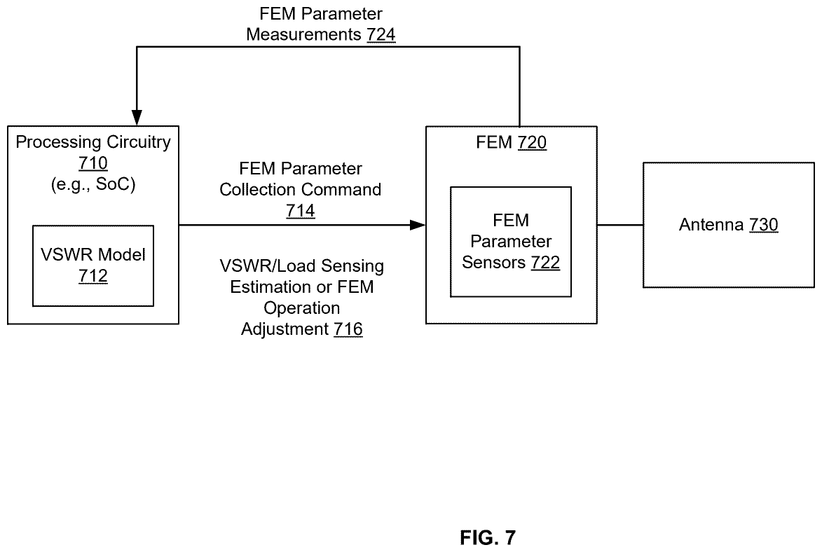

FIG. 7 illustrates an example of an artificial intelligence (AI)-based approach for sensing an antenna property, in accordance with various embodiments. Herein above, a LUT is predefined and used to estimate the VSWR and/or antenna load. In comparison, rather than using a LUT, an AI model can be trained to estimate the VSWR and/or antenna load. The training data can include measurement data across different FEM parameters, frequencies, phase shifts, non-FEM parameters, and types of FEMs. More particularly, for a given FEM parameter, a FEM parameter measurement can be generated under a known antenna load or VSWR and known conditions (e.g., phase shift, frequency, temperature, etc.). The known antenna load or VSWR can be stored as ground truth data. The FEM parameter measurement can be input along with the known conditions that then outputs an estimated antenna load or VSWR. This estimation can be compared to the ground truth to determine a difference. This difference can be defined in a loss function. The parameters of the AI model can then be updated to minimize the loss function (e.g., the AI model can be implemented as an artificial neural network, where the parameter updates can be via a backpropagation algorithm).

In FIG. 7, the AI model is shown as a VSWR model 712 implemented at processing circuitry 710 (e.g., an SoC). The VSWR model 712 is trained to estimate a VSWR value, which can be pre-associated with an antenna load.

The processing circuitry 710 can be connected to a FEM 720 that, in turn, is connected to an antenna. The FEM 720 can include FEM parameter sensors 722 that generates FEM parameter measurements 724. These measurements 724 can be provided (e.g., via a radio frequency front end interface) from the FEM 720 to the processing circuitry 710. The processing circuitry 710 can store the VSWR model 712 as program code. Upon execution of the program code, the FEM parameter measurements 724 can be input to the VSWR model 720 that then outputs a VSWR estimation (which can be pre-associated, via laboratory measurements with an antenna load variation).

As illustrated in FIG. 7, the FEM 720 can be triggered to generate the FEM parameter measurements 724 based on a FEM parameter collection command 714 sent from the processing circuitry 710. Nonetheless, such a command may not be used.

As also illustrated in FIG. 7, the processing circuitry 710 can output to the FEM 720 VSWR and/or load sensing estimation or a FEM operation adjustment 716. In the case of a VSWR estimation being received by the FEM 720, the FEM 720 can execute logic to estimate a variation to the antenna load from this VSWR estimation and/or to control a FEM operation based on the VSWR estimation and/or the antenna load variation. In the case of a FEM operation adjustment 716 is received by the FEM 720, the FEM 720 can adjust its operation accordingly.

FIG. 8 illustrates another example of an AI-based approach for sensing an antenna property, in accordance with various embodiments. The AI-based approach of FIG. 8 is similar to that of FIG. 7, except that the AI model is implemented at a FEM 820 rather than processing circuitry 810. In the interest of brevity, the similarities are not repeated and equivalently apply herein.

As shown in FIG. 8, the processing circuitry 810 is connected to the FEM 820 that, in turn, is connected to an antenna 830. The FEM 820 stores program code that represents a VSWR model 822. FEM parameters measurements can be generated by FEM parameter sensors of the FEM 820. Upon execution of the VSWR model 822, these measurements can be input to the VSWR model 822. The VSWR model 822 outputs a VSWR estimation, which can be pre-associated with antenna load variation.

Such a VSWR and/or load sensing estimation 824 can be provided to the processing circuitry 810 (e.g., via a radio frequency front end interface). It is possible that the processing circuitry 810 executes logic that determines an adjustment to an operation of the FEM 820 based on the VSWR and/or load sensing estimation 824. In this case, the processing circuitry 810 can output a FEM operation adjustment 818 to FEM 820 indicating the needed adjustment. Alternatively, the FEM 820 itself can execute such logic to determine the adjustment.

As further illustrated in FIG. 8, the FEM 820 can be triggered to generate the VSWR and/or load sensing estimation 824 based on a FEM parameter collection command 814 sent from the processing circuitry 810. Nonetheless, such a command may not be used.

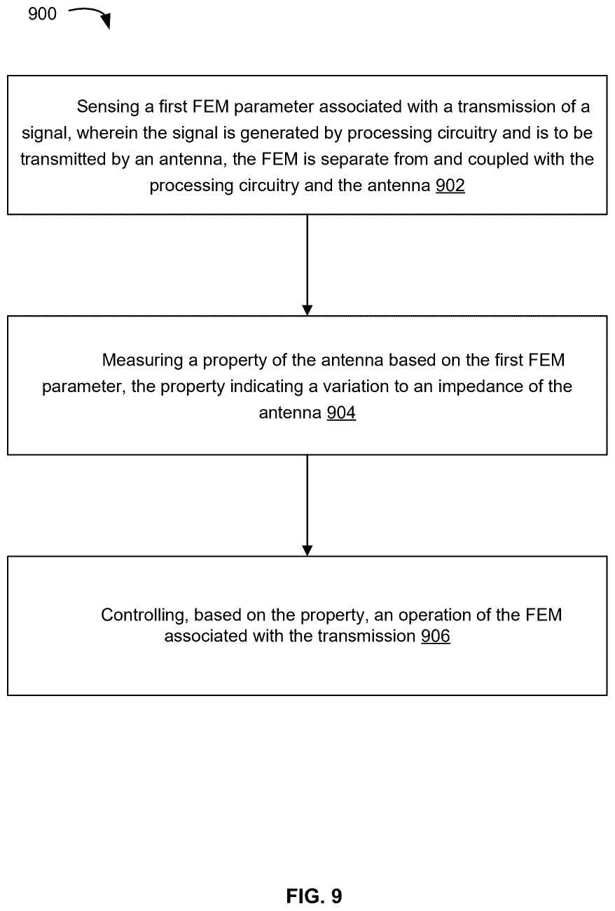

As described in FIGS. 8-9, processing circuitry can control a FEM to monitor FEM parameter variations, VSWR variations, and/or antenna load variations. Additionally, the processing circuitry can activate a termination component of the FEM by sending a request indicating that the FEM parameters are to be measured, the VSWR measurement is to be estimated, and/or the antenna load is to be estimated. In this case, because in the termination mode, the antenna is deactivated and the termination component is activated, the signal transmission can be interrupted or halted. Accordingly, the processing circuitry's control via the request can enable the processing circuitry to activate the termination component when the processing circuitry has no traffic data to send to minimize the impact to the data throughput.

FIG. 9 illustrates an example of an operational flow/algorithmic structure 900 for sensing an antenna property based on a FEM parameter, in accordance with various embodiments. The operational flow/algorithmic structure 900 can be implemented by an apparatus of a device (e.g., the apparatus includes a FEM, such as the FEM 130 of FIG. 1). In some embodiments, the operational flow/algorithmic structure 900 may be implemented by executing instructions stored in a tangible, non-transitory, computer-readable storage medium, such as a memory of the device. While the operational flow/algorithmic structure 900 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 900 includes, at 902, sensing a first FEM parameter associated with a transmission of a signal, wherein the signal is generated by processing circuitry and is to be transmitted by an antenna, the FEM is separate from and coupled with the processing circuitry and the antenna. Examples of the FEM, processing circuitry, and antenna are described in the figures herein above. The first FEM parameter can be any of gain, current, output power, or EVM, for instance and can be sensed by a FEM parameter sensor of the FEM.

In an example, the operational flow/algorithmic structure 900 includes, at 904, measuring a property of the antenna based on the first FEM parameter, the property indicating a variation to an impedance of the antenna. For instance, the property is a VSWR and can be measured based on the value of the first FEM parameter. This value can be used in a look-up of a LUT that associates VSWRs with FEM parameter measurements, and possibly antenna load variations, and non-FEM parameters (e.g., temperature).

In an example, the operational flow/algorithmic structure 900 includes, at 906, controlling, based on the property, an operation of the FEM associated with the transmission. For instance, the gain of a PA of the FEM and/or a target SAR backoff power of the FEM can be adjusted.

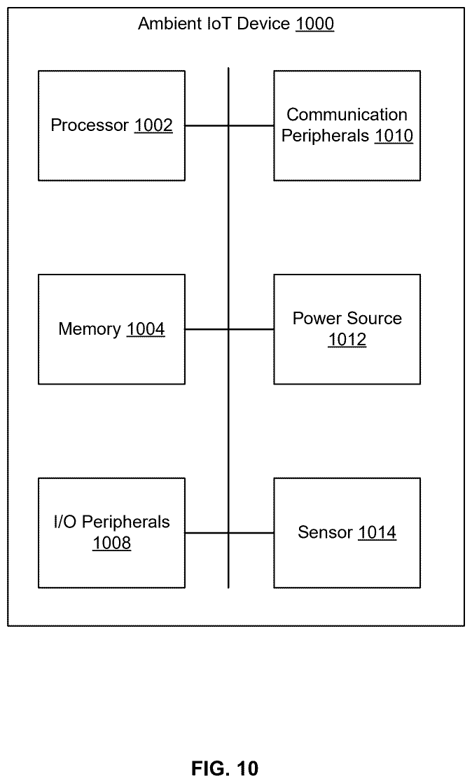

FIG. 10 illustrates a device 1000, in accordance with some embodiments. The device 1000 is an example of the devices described herein above. For example, the device 1000 can implement a FEM configured to measure FEM parameters and/or estimate an antenna property, such as VSWR or impedance variation, based on such measurements.

In an example, the device 1000 includes a power source 1012 that can supply power to other components of the device 1000. The power source 1012 can include a power storage component (e.g., a set of capacitors, a rechargeable battery cell, etc.) and an energy harvesting component (e.g., a solar panel). The other components can include at least a processor 1002, a memory 1004, input/output peripherals (I/O) 1008, communication peripherals 1010, and sensors 1014. An interface bus can be configured to communicate, transmit, and transfer data, controls, and commands among the various components of the device 1000. The memory 1004 can include computer-readable storage media, such as RAM; ROM; electrically erasable programmable read-only memory (EEPROM); hard drives; CD-ROMs; optical storage devices; magnetic storage devices; electronic non-volatile computer storage, for example, Flash® memory; and other tangible storage media. Any of such computer readable storage media can be configured to store instructions or program codes embodying aspects of the disclosure. The memory 1004 can also include computer readable signal media. A computer readable signal medium includes a propagated data signal with computer readable program code embodied therein. Such a propagated signal takes any of a variety of forms including, but not limited to, electromagnetic, optical, or any combination thereof. A computer readable signal medium includes any computer readable medium that is not a computer readable storage medium and that can communicate, propagate, or transport a program for use in connection with the device 1000.

Further, the memory 1004 includes an operating system, programs, and applications. The processor 1002 is configured to execute the stored instructions and includes, for example, a logical processing unit, a microprocessor, a digital signal processor, and other processors. The I/O peripherals 1008 can include user interfaces, such as a light source; an alarm device; a keyboard; screen (e.g., a touch screen); microphone; speaker; other input/output devices; and computing components, such as graphical processing units; serial ports; parallel ports; universal serial buses; and other input/output peripherals. The sensors 1014 can be configured to detect events or changes in their environment and send the information (sensor data) about the detected events to some other device, module, or system. Examples of such sensors 1014 include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lens-less apertures); light detection and ranging sensors; proximity sensors (for example, infrared radiation detector and the like); depth sensors; ambient light sensors; ultrasonic transceivers; and microphones or other like audio capture devices. The communication peripherals 1010 are configured to facilitate communication between the device 1000 and other systems over a communications network and include, for example, a network interface controller, modem, wireless and wired interface cards, antenna, and other communication peripherals. The communication peripherals 1010 can include a transmitter having components as described in the previous figures.

### EXAMPLES

In the following sections, further exemplary embodiments are provided.

Example 1 includes a device comprising: processing circuitry configured to output a signal; and a front end module (FEM) separate from and coupled with the processing circuitry and an antenna characterized by an impedance, the FEM comprising (i) a set of power amplifiers configured to amplify the signal for transmission by the antenna, (ii) a first component configured to measure a first FEM parameter associated with the transmission, and (iii) a controller configured to estimate a property of the antenna based on the first FEM parameter and control based on the property an operation of the FEM associated with the transmission, the property indicating a variation to the impedance of the antenna.

Example 2 includes the device of example 1, wherein the FEM further comprises a second component configured to measure a second FEM parameter associated with the transmission, wherein estimating the property is further based on the second FEM parameter.

Example 3 includes the device of example 2, wherein the property includes a voltage standing wave ratio (VSWR), wherein the first FEM parameter comprises one of a current, a gain, a power output, or an error vector magnitude, and wherein the second FEM parameter comprises another one of the current, the gain, the power output, or the error vector magnitude.

Example 4 includes the device of example 2, wherein the first component and the first FEM parameter are a current sensor and a current, respectively, and wherein the second component and the second FEM parameter are a power detector and a gain, respectively.

Example 5 includes the device of any example 1-4, the FEM further comprising a termination component having a matching impedance corresponding to the impedance of the antenna, wherein a first measurement of the first FEM parameter is generated while the termination component is deactivated by the controller, a second measurement of the first FEM parameter is generated while the termination component is activated by the controller, and the VSWR measurement is estimated based on the first measurement and the second measurement.

Example 6 includes the device of example 5, wherein a difference between the first measurement and the second measurement indicates a contribution of a non-FEM parameter to the VSWR measurement, and wherein the controller is further configured to estimate the VSWR measurement by at least removing the contribution based on calibration data associated with the impedance of the antenna.

Example 7 includes the device of any example 5-6, wherein the controller is configured to activate the termination component based on a request of the processing circuitry indicating that the VSWR measurement is to be estimated.

Example 8 includes the device of any example 5-7, wherein the matching impedance of the termination component is adjustable to mimic a plurality of antenna loads, and wherein each one of the plurality of antenna loads is associated with calibration data.

Example 9 includes the device of any example 1-8, wherein the controller is configured to estimate the property based on a request of the processing circuitry indicating that the property is to be estimated in association with the transmission of the signal.

Example 10 includes the device of any example 1-8, wherein the controller is configured to estimate the property independently of a control of the processing circuitry.

Example 11 includes the device of any example 1-10, wherein the FEM is configured to store look-up data that associates a variation to the first FEM parameter with the variation to the impedance of the antenna, wherein the controller is configured to estimate the property based on a look-up of the look-up data using a measurement of the first FEM parameter.

Example 12 includes the device of any example 1-11, wherein the property includes a voltage standing wave ratio (VSWR), wherein the FEM is configured to store program code corresponding to an artificial intelligence model trained to output VSWR estimations, wherein the VSWR measurement is estimated by providing a measurement of the first FEM parameter as an input in the execution of the program code.

Example 13 includes the device of any example 1-12, wherein the controller is configured to cause the first component to generate a first measurement of the first FEM parameter based on a first signal frequency, and cause the first component to generate a second measurement of the first FEM parameter based on a second signal frequency, wherein the property is estimated based on the first measurement and the second measurement.

Example 14 includes the device of any example 1-13, wherein the first FEM parameter is measured based on a modulation of the signal corresponding to traffic being transmitted from the processing circuitry or based on a continuous wave signal while no traffic is being transmitted from the processing circuitry.

Example 15 includes an apparatus comprising: an antenna characterized by an impedance; and a front end module (FEM) coupled with the antenna, separate from and configured to be coupled with processing circuitry, and comprising (i) a set of power amplifiers configured to amplify a signal of the processing circuitry for transmission by the antenna, (ii) a first component configured to measure a first FEM parameter associated with the transmission, and (iii) a controller configured to estimate a property of the antenna based on the first FEM parameter and control, the property indicating a variation to the impedance corresponding to the antenna based on the property an operation of the FEM associated with the transmission.

Example 16 includes the apparatus of example 15, wherein the operation of the FEM is adjusted by changing a gain of at least one power amplifier of the set of power amplifiers.

Example 17 includes the apparatus of any example 15-16, wherein the operation of the FEM is adjusted by changing a back-off power associated with a specific absorption rate (SAR) in the transmission of the signal.

Example 18 includes method implemented by a front end module (FEM), the method comprising: sensing a first FEM parameter associated with a transmission of a signal, wherein the signal is generated by processing circuitry and is to be transmitted by an antenna, the FEM is separate from and coupled with the processing circuitry and the antenna; measuring a property of the antenna based on the first FEM parameter, the property indicating a variation to an impedance of the antenna; and controlling, based on the property, an operation of the FEM associated with the transmission.

Example 19 includes the method of example 18, wherein the property includes a first voltage standing wave ratio (VSWR), wherein the first FEM parameter measurement includes a gain that is measured by a power detector of the FEM, and wherein the method further comprises: measuring a second VSWR based on a forward power measurement by the power detector and a reverse power measurement by the power detector.

Example 20 includes the method of any example 18-19, wherein the signal and the antenna are a first signal and a first antenna, respectively, and wherein the method further comprises: measuring, by the FEM, an output power associated with the transmission of the first signal by the first antenna; measuring, by the FEM, an input power of a second signal received by a second antenna coupled with the FEM, the second signal corresponding to a reception of the first signal by the second antenna; and estimating, by the FEM, an antenna isolation between the first antenna and the second antenna based on the output power and the input power.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A device comprising:
processing circuitry configured to output a signal; and
a front end module (FEM) coupled with the processing circuitry and with an antenna characterized by an impedance, the FEM comprising:
(i) a set of power amplifiers configured to amplify the signal for transmission by the antenna,
(ii) a first component configured to measure a first FEM parameter associated with the transmission, and
(iii) a controller configured to estimate a property of the antenna based on the first FEM parameter and control based on the property an operation of the FEM associated with the transmission, the property indicating a variation to the impedance of the antenna.

2. The device of claim 1, wherein the FEM is separate from the processing circuitry and from the antenna and further comprises a second component configured to measure a second FEM parameter associated with the transmission, wherein estimating the property is further based on the second FEM parameter.

3. The device of claim 2, wherein the property includes a voltage standing wave ratio (VSWR), wherein the first FEM parameter comprises one of a current, a gain, a power output, or an error vector magnitude, and wherein the second FEM parameter comprises another one of the current, the gain, the power output, or the error vector magnitude.

4. The device of claim 2, wherein the first component and the first FEM parameter are a current sensor and a current, respectively, and wherein the second component and the second FEM parameter are a power detector and a gain, respectively.

5. The device of claim 1, the FEM further comprising a termination component having a matching impedance corresponding to the impedance of the antenna, wherein a first measurement of the first FEM parameter is generated while the termination component is deactivated by the controller, a second measurement of the first FEM parameter is generated while the termination component is activated by the controller, and the VSWR measurement is estimated based on the first measurement and the second measurement.

6. The device of claim 5, wherein a difference between the first measurement and the second measurement indicates a contribution of a non-FEM parameter to the VSWR measurement, and wherein the controller is further configured to estimate the VSWR measurement by at least removing the contribution based on calibration data associated with the impedance of the antenna.

7. The device of claim 5, wherein the controller is configured to activate the termination component based on a request of the processing circuitry indicating that the VSWR measurement is to be estimated.

8. The device of claim 5, wherein the matching impedance of the termination component is adjustable to mimic a plurality of antenna loads, and wherein each one of the plurality of antenna loads is associated with calibration data.

9. The device of claim 1, wherein the controller is configured to estimate the property based on a request of the processing circuitry indicating that the property is to be estimated in association with the transmission of the signal.

10. The device of claim 1, wherein the controller is configured to estimate the property independently of a control of the processing circuitry.

11. The device of claim 1, wherein the FEM is configured to store look-up data that associates a variation to the first FEM parameter with the variation to the impedance of the antenna, wherein the controller is configured to estimate the property based on a look-up of the look-up data using a measurement of the first FEM parameter.

12. The device of claim 1, wherein the property includes a voltage standing wave ratio (VSWR), wherein the FEM is configured to store program code corresponding to an artificial intelligence model trained to output VSWR estimations, wherein the VSWR measurement is estimated by providing a measurement of the first FEM parameter as an input in the execution of the program code.

13. The device of claim 1, wherein the controller is configured to cause the first component to generate a first measurement of the first FEM parameter based on a first signal frequency, and cause the first component to generate a second measurement of the first FEM parameter based on a second signal frequency, wherein the property is estimated based on the first measurement and the second measurement.

14. The device of claim 1, wherein the first FEM parameter is measured based on a modulation of the signal corresponding to traffic being transmitted from the processing circuitry or based on a continuous wave signal while no traffic is being transmitted from the processing circuitry.

15. An apparatus comprising:
an antenna characterized by an impedance; and
a front end module (FEM) coupled with the antenna, configured to be coupled with processing circuitry, and comprising:
(i) a set of power amplifiers configured to amplify a signal of the processing circuitry for transmission by the antenna,
(ii) a first component configured to measure a first FEM parameter associated with the transmission, and
(iii) a controller configured to estimate a property of the antenna based on the first FEM parameter and control, the property indicating a variation to the impedance corresponding to the antenna based on the property an operation of the FEM associated with the transmission.

16. The apparatus of claim 15, wherein the operation of the FEM is adjusted by changing a gain of at least one power amplifier of the set of power amplifiers.

17. The apparatus of claim 15, wherein the operation of the FEM is adjusted by changing a back-off power associated with a specific absorption rate (SAR) in the transmission of the signal.

18. A method implemented by a front end module (FEM), the method comprising:
sensing a first FEM parameter associated with a transmission of a signal, wherein the signal is generated by processing circuitry and is to be transmitted by an antenna, the FEM is coupled with the processing circuitry and the antenna;
measuring a property of the antenna based on the first FEM parameter, the property indicating a variation to an impedance of the antenna; and
controlling, based on the property, an operation of the FEM associated with the transmission.

19. The method of claim 18, wherein the property includes a first voltage standing wave ratio (VSWR), wherein the first FEM parameter measurement includes a gain that is measured by a power detector of the FEM, and wherein the method further comprises:
measuring a second VSWR based on a forward power measurement by the power detector and a reverse power measurement by the power detector.

20. The method of claim 18, wherein the signal and the antenna are a first signal and a first antenna, respectively, and wherein the method further comprises:
measuring, by the FEM, an output power associated with the transmission of the first signal by the first antenna;
measuring, by the FEM, an input power of a second signal received by a second antenna coupled with the FEM, the second signal corresponding to a reception of the first signal by the second antenna; and
estimating, by the FEM, an antenna isolation between the first antenna and the second antenna based on the output power and the input power.
